(19) United States
(12) Patent Application Publication
(10) Pub. No.: US 2008/0158141 A1
(43) Pub. Date: Jul. 3, 2008

(54) Display method and display device

(75) Inventors: Toshiaki Yoshihara, Kawasaki (JP); Tetsuya Makino, Kakogawa (JP); Shinji Tadaki, Kawasaki (JP); Hironori Shiroto, Kobe (JP); Yoshinori Kiyota, Kawasaki (JP); Keiichi Betsui, Yokohama (JP)

Correspondence Address: GREER, BURNS & CRAIN, 300 S WACKER DR, 25TH FLOOR, CHICAGO, IL, 60606, US

(73) Assignee: Fujitsu Limited, Kawasaki-shi (JP)

(21) Appl. No.: 12/075,415

(22) Filed: Mar. 10, 2008

Related U.S. Application Data
(63) Continuation of application No. PCT/JP2005/016763, filed on Sep. 12, 2005.

(51) Int. Cl. G09G 3/36

(52) U.S. Cl. 345/102

(57) ABSTRACT

In a field sequential display method the light emission intensities of the luminous colors are controlled to realize a plurality of color reproduction regions having different areas and make the color purity variable. In the case of high-resolution image display, a first control method is adopted in which in synchronism with the input of the pixel data of one of the luminous colors, the light of the one of the luminous colors is emitted and the lights of the other luminous colors are not emitted. In the case of coarse image display, a second control method is adopted in which in synchronism with the input of the pixel data of one of the luminous colors, the light of the one of the luminous colors and the lights of the other luminous colors are emitted. By the second method, the color purity is slightly decreased to suppress the visual irritation.

This application is a Continuation Application under 35 U.S.C.§ 111(a) of PCT International Application No. PCT/JP2005/016763 which has an international filing date of Sep. 12, 2005 and designated the United States of America.

### BACKGROUND

1. Technical Field

The present invention relates to a field sequential display method and display device in which the switching among the lights of the colors incident on the display element and the light control at the display element by the display data of the colors are synchronized with each other to perform color display.

2. Description of Related Art

With the recent progression of the so-called information-oriented society, electronic apparatuses typified by personal computers and PDAs (personal digital assistants) have come to be widely used. The spread of such electronic apparatuses has produced a demand for portable apparatuses that can be used both in offices and outdoors, and such apparatuses are required to be reduced in size and weight. As a means of achieving this object, liquid crystal display devices are widely used. Liquid crystal display devices are an indispensable technology not only for the reduction in size and weight but also for the reduction in the power consumption of battery driven portable electronic apparatuses.

Liquid crystal display devices are broadly classified into a reflective type and a transmissive type. The reflective type has a structure in which the light beam incident from the front surface of the liquid crystal panel is reflected at the back surface of the liquid crystal panel and the image is made visually perceived by means of the reflected light. The transmissive type has a structure in which the image is made visually perceived by means of the transmitted light from a light source (backlight) provided on the back surface of the liquid crystal panel. Since the reflective type in which the amount of reflected light varies depending on the environmental condition is inferior in viewability, transmissive type color liquid crystal display devices using color filters are generally used as display devices, particularly, for personal computers and the like that perform multi-color or full-color display.

At present, active driven type liquid crystal display devices using switching elements such as TFTs (thin film transistors) are widely used as color liquid crystal display devices. In the TFT driven liquid crystal display devices, although the display quality is high, since the light transmittance of the liquid crystal panel is only approximately several percents under present circumstances, a high-brightness backlight is necessary to obtain high screen brightness. For this reason, the power consumption of the backlight is increased. In addition, since color filters are used for color display, one pixel is necessarily formed of three subpixels, so that high resolution is difficult to achieve and the display color purity is insufficient.

To solve this problem, the present inventor et al. have developed field sequential type liquid crystal display devices (see, for example, Non-Patent Documents 1, 2 and 3). In the field sequential type liquid display devices, compared with the color filter type liquid crystal display devices, since no subpixel is required, higher-resolution display can be easily realized, and since the luminous colors of the light source can be used for display as they are without the use of color filters, the display color purity is excellent. Further, since light use efficiency is high, power consumption is low. However, to realize the field sequential type liquid crystal display devices, it is essential that the liquid crystal have a fast responsivity (equal to or less than 2 ms).

Accordingly, to achieve a fast responsivity in the field sequential type liquid crystal display devices having excellent advantages as mentioned above, the present inventor et al. have researched and developed the driving of a liquid crystal such as a ferroelectric liquid crystal having spontaneous polarization from which a fast responsivity 100 to 1000 times that of conventional devices can be expected, by switching elements such as TFTs (see, for example, Patent Document 1). In the ferroelectric liquid crystal, the direction of major axis of the liquid crystal molecules tilts by voltage application. A liquid crystal panel holding the ferroelectric liquid crystal is sandwiched between two polarizing plates the polarization axes of which are orthogonal to each other, and the transmitted light intensity is changed by using the birefringence caused by the change of the major axis direction of the liquid crystal molecules.

[Patent Document 1] Japanese Patent Application Laid-Open No. H11-119189

[Non-Patent Document 1] T. Yoshihara et al., ILCC 98, P1-074, issued in 1998

[Non-Patent Document 2] T. Yoshihara et al., AM-LCD′ 99 Digest of Technical Papers, p. 185, issued in 1999

[Non-Patent Document 3] T. Yoshihara et al., SID′00 Digest of Technical Papers, p. 1176, issued in 2000

### SUMMARY

The field sequential type liquid crystal display devices are excellent in display color purity. However, since the purity of the display colors is too high for some kinds of display images, the display sometimes appears to be irritating to view. In particular, when single-color display in red, green and blue is provided in a large area in an enlarged display or the like, the display appears to be more irritating to view. On the other hand, when fine display is provided, if the color purity is low, fine areas are recognized as black. Therefore, in order that colors are recognized, the color purity is necessarily high.

As mentioned above, in the case of coarse image display, display with color purity suppressed to a certain extent is required, and in the case of fine image display, display with high color purity is required.

An object is to provide a field sequential display method and display device in which a plurality of kinds of color reproduction regions with different patterns can be presented and the color purity (color reproduction region) can be changed according to the image to be displayed.

Another object is to provide a field sequential display method and display device capable of suppressing the occurrence of color breakup.

### Means for Solving the Problems

In a field sequential display method according to an aspect in which switching among a plurality of luminous colors of a light source is made with time and light emission timings of the luminous colors and input of pixel data of the luminous colors according to a display image are synchronized with each other to perform color display, light emission intensities of the luminous colors are controlled to obtain a plurality of color reproduction regions having different areas.

In a field sequential display device according to an aspect in which switching among a plurality of luminous colors of a light source is made with time and light emission timings of the luminous colors and input of pixel data of the luminous colors to a display element according to a display image are synchronized with each other to perform color display, control means for controlling light emission intensities of the luminous colors is provided, and a plurality of color reproduction regions having different areas are obtained by control by the control means.

In the display method and the display device according to the aspects, the light emission intensities of the luminous colors are controlled to realize a plurality of kinds of color reproduction regions having different patterns. Therefore, the color purity (color lo reproduction region) can easily be adjusted without the display data converted. Consequently, in the case of high-resolution image display, the colors are surely recognized as high-color-purity display, and in the case of coarse display such as enlarged display, the color purity is decreased to suppress the intenseness (intensity of visual irritation) of the display color.

### Effects of the Invention

Since a plurality of patterns of color reproduction regions can be presented, that is, variable color purity can be realized, switching can be made between display required for coarse image display in which the color purity is suppressed to a certain extent and there is little irritation and high-resolution display required for fine image display in which the color purity is high.

Moreover, since the color reproduction region (color purity) is made variable by switching between the first control method in which in synchronism with the input of the pixel data of one specific luminous color, the light of the one specific color is emitted and the lights of the other luminous colors are not emitted and the second control method in which in synchronism with the input of the pixel data of one specific luminous color, the light of the one specific color and the lights of the other luminous colors are emitted, the light emission sequence of the light source and the light emission intensities of the luminous colors are controlled without the display data converted, whereby the color reproduction region (color purity) can easily be adjusted. Moreover, since the second control method is performed, the occurrence of color breakup can be suppressed.

### BRIEF DESCRIPTION OF THE SEVERAL VIEWS OF THE DRAWINGS

FIG. 1 is a block diagram showing the circuit arrangement of a liquid crystal display device of an embodiment;

FIG. 2 is a schematic cross-sectional view of a liquid crystal panel and a backlight;

FIG. 3 is a schematic view showing an example of the overall structure of the liquid crystal display device;

FIG. 4 is a schematic view showing an example of the structure of an LED array;

FIG. 5 is a view showing a driving sequence of a first control method;

FIG. 6 is a view showing a driving sequence of a first example of a second control method;

FIG. 7 is a view showing a driving sequence of a second example of the second control method; and

FIG. 8 is a view showing a driving sequence of another example of the second control method.

### DESCRIPTION OF THE NUMERALS

7 LED array
13 liquid crystal layer
21 liquid crystal panel
22 backlight
35 backlight control circuit
36 control method determining circuit
41 TFT

### DETAILED DESCRIPTION

Embodiments are described with reference to the drawings. While in the following description, a field sequential liquid crystal display device in which the display element is a transmissive type liquid crystal display element and the light source is an LED (light emitting diode) array will be described as an example.

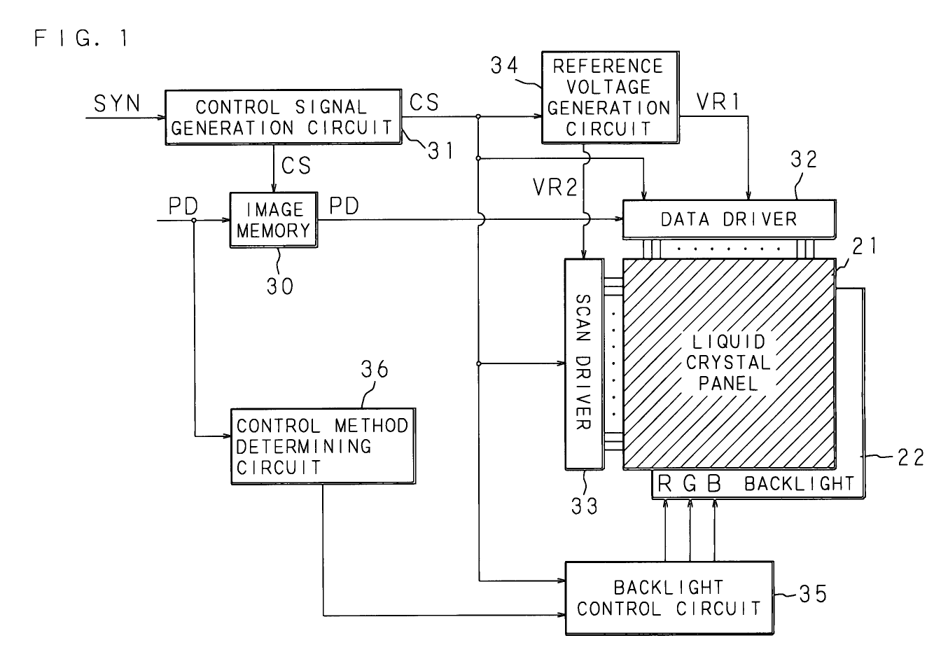

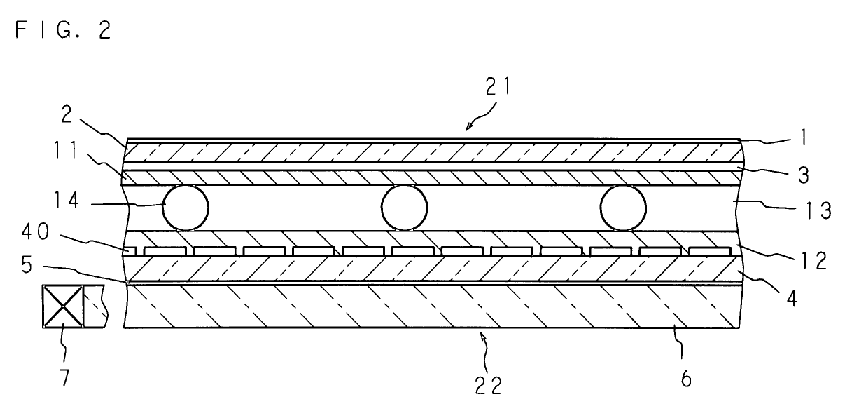

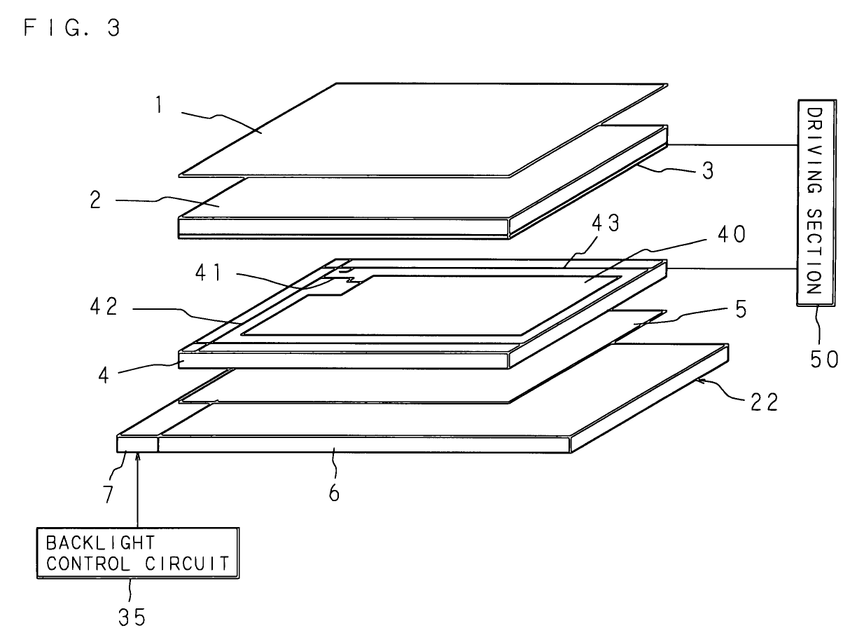

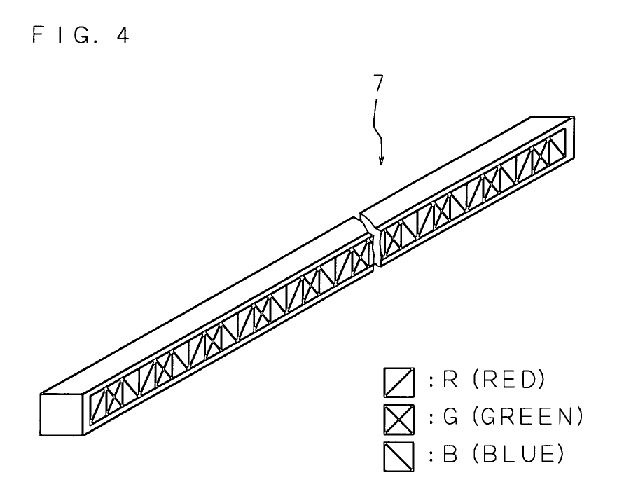

FIG. 1 is a block diagram showing the circuit arrangement of a liquid crystal display device an embodiment. FIG. 2 is a schematic cross-sectional view of a liquid crystal panel and a backlight of the liquid crystal display device. FIG. 3 is a schematic view showing an example of the overall structure of the liquid crystal display device. FIG. 4 is a schematic view showing an example of the structure of an LED array serving as the light source of the backlight.

In FIG. 1, reference numerals 21 and 22 represent the liquid crystal panel and the backlight the cross-sectional structures of which are shown in FIG. 2. As shown in FIG. 2, the backlight 22 includes an LED array 7 and a light directing and diffusing plate 6. As shown in FIGS. 2 and 3, the liquid crystal panel 21 includes a polarizer 1, a glass substrate 2, a common electrode 3, a glass substrate 4 and a polarizer 5 which are laminated in this order from the upper layer (obverse surface) side to the lower layer (back surface) side, and pixel electrodes 40 arranged in matrix are formed on the common electrode 3 side surface of the glass substrate 4.

An alignment film 12 is disposed on the upper surfaces of the pixel electrodes 40 on the glass substrate 4, and an alignment film 11 is disposed on the lower surface of the common electrode 3. A liquid crystal material is filled between the alignment films 11 and 12 to form a liquid crystal layer 13. Reference numeral 14 represents spacers for holding the thickness of the liquid crystal layer 13.

A driving section 50 including a data driver 32 and a scan driver 33 is connected between the common electrode 3 and the pixel electrodes 40. The data driver 32 is connected to the TFTs 41 through signal lines 42, and the scan driver 33 is connected to the TFTs 41 through scanning lines 43. The turning on and off of the TFTs 41 is controlled by the scan driver 33. The pixel electrodes 40 are each connected to the TFT 41. Consequently, the transmitted light intensity of each pixel is controlled by the signal from the data driver 32 that is fed through the signal line 42 and the TFT 41.

The backlight 22 is situated on the lower layer (back surface) side of the liquid crystal panel 21, and the LED array 7 is provided in a condition of facing an end surface of the light directing and diffusing plate 6 constituting a light emitting area. As shown in the schematic view of FIG. 4, the LED array 7 has a plurality of LEDs in which one chip is constituted by LED elements emitting lights of three primary colors, that is, red (R), green (G) and blue (B), on the surface opposite to the light directing and diffusing plate 6. In the subframes of red, green and blue, the turning on of the LED elements of red, green and blue are controlled, respectively. The light directing and diffusing plate 6 functions as the light emitting area by directing light from the LEDs of the LED arrays 7 to the entire area of its own surface and diffusing the light to the upper surface. Since LEDs are used as the light sources for display, switching between turning on and off can be easily made, and it is easy to partially turn on the backlight 22.

The liquid crystal panel 21 and the backlight 22 capable of time-division light emission of red, green and blue in each turning-on area are placed one on another. The turning-on timing, the luminous colors, and light emission intensities of the backlight 22 are controlled in synchronism with the data writing scanning, based on the display data, on the liquid crystal panel 21. This control of the backlight 22 will be described later in detail.

In FIG. 1, reference numeral 31 represents a control signal generating circuit that is fed with a synchronization signal SYN from a personal computer and generates various control signals CS necessary for display. An image memory 30 outputs pixel data PD to the data driver 32. Based on the pixel data PD, and the control signal CS for changing the polarity of the applied voltage, a voltage is applied to the liquid crystal panel 21 through the data driver 32.

The control signal generating circuit 31 outputs the control signal CS to a reference voltage generating circuit 34, the data driver 32, the scan driver 33, and a backlight control circuit 35. The reference voltage generating circuit 34 generates reference voltages VR1 and VR2, and outputs the generated reference voltages VR1 and VR2 to the data driver 32 and the scan driver 33, respectively. The data driver 32 outputs a signal to the signal lines 42 of the pixel electrodes 40 based on the pixel data PD from the image memory 30 and the control signal CS from the control signal generating circuit 31. In synchronism with the output of this signal, the scan driver 33 sequentially scans the scanning lines 43 of the pixel electrodes 40 line by line. The backlight control circuit 35 feeds the backlight 22 with a driving voltage to cause the backlight 22 to emit red light, green light and blue light.

Reference numeral 36 represents a control method determining circuit that determines the backlight control method in the backlight control circuit 35. The control method determining circuit 36 is fed with the pixel data PD for display, determines the resolution of the display image based on the pixel data PD being fed, determines the backlight control method to be adopted, according to the determined resolution, and notifies the backlight control circuit 35 of the determined control method. The backlight control circuit 35 controls the emission timings and emission intensities of the red light, green light and blue light from the backlight 22 according to the control method that the backlight control circuit 35 is notified of.

The TFT 41 is driven according to the signal output from the data driver 32 and the scanning of the scan driver 33, a voltage is applied to the pixel electrode 40, and the transmitted light intensity of the pixel is controlled. When receiving the control signal CS, the backlight control circuit 35 feeds the backlight 22 with a driving voltage to cause the LED elements of red, green and blue of the LED array 7 of the backlight 22 to emit light in a time-division manner so that red light, green light and blue light are emitted. In this manner, the control of turning on of each color of the backlight 22 and the data writing scanning on the liquid crystal panel 21 are synchronized with each other to perform color display.

The backlight control method in the backlight control circuit 35 includes: a first control method in which in synchronism with the input of the pixel data of one specific color, the light of the one specific color is emitted and the lights of the other colors are not emitted; and a second control method in which in synchronism with the input of the pixel data of the light of one specific color, the light of the one specific color and the lights of the other colors are emitted.

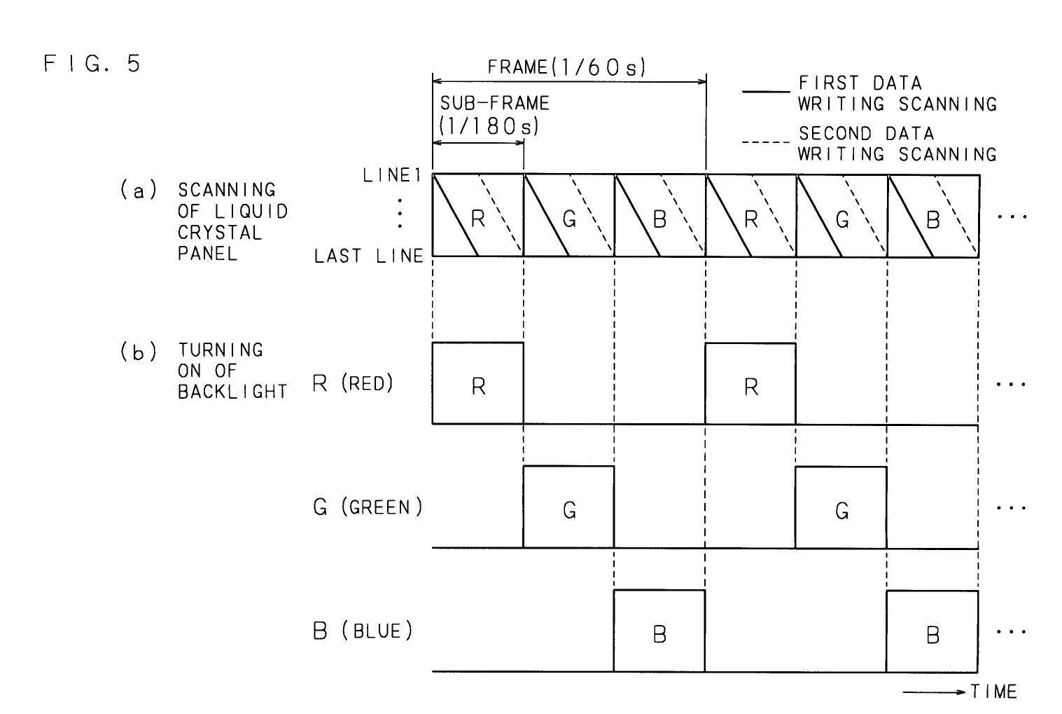

FIG. 5 shows a driving sequence of the first control method. (a) of FIG. 5 shows the scanning timing of each line of the liquid crystal panel 21. (b) of FIG. 5 shows the turning-on timings and light emission intensities of red, green and blue of the backlight 22.

One frame (period: 1/60 s) is divided into three subframes (period: 1/180 s) with the frame frequency being 60 Hz. As shown in (a) of FIG. 5, for example, in the first subframe in one frame, writing scanning of the pixel data of red is performed twice. In the next second subframe, writing scanning of the pixel data of green is performed twice. In the last third subframe, writing scanning of the pixel data of blue is performed twice. In the subframe of each of red, green and blue, in the first data writing scanning (first half, a voltage of a polarity where bright display is obtained is applied to the liquid crystal of each pixel in accordance with the display data through the switching of the TFT 41. The second data writing scanning (latter half) is performed based on the display data the same as that used in the first data writing scanning. A voltage, which is applied to the liquid crystal of each pixel, is dissimilar in polarity and equal in magnitude to that used in the first data writing scanning. Thereby a dark display is obtained that can be regarded as substantially black display compared with the first data writing scanning.

In the control of turning on of red, green and blue of the backlight 22, as shown in (b) of FIG. 5, in the first subframe in which writing scanning of the pixel data of red is performed, only the red light is emitted. In the second subframe in which writing scanning of the pixel data of green is performed, only the green light is emitted. In the third subframe in which writing scanning of the pixel data of blue is performed, only the blue light is emitted. The first control method is suitable for high-resolution image display in which the color reproduction region in the chromaticity diagram is large and the color purity is high.

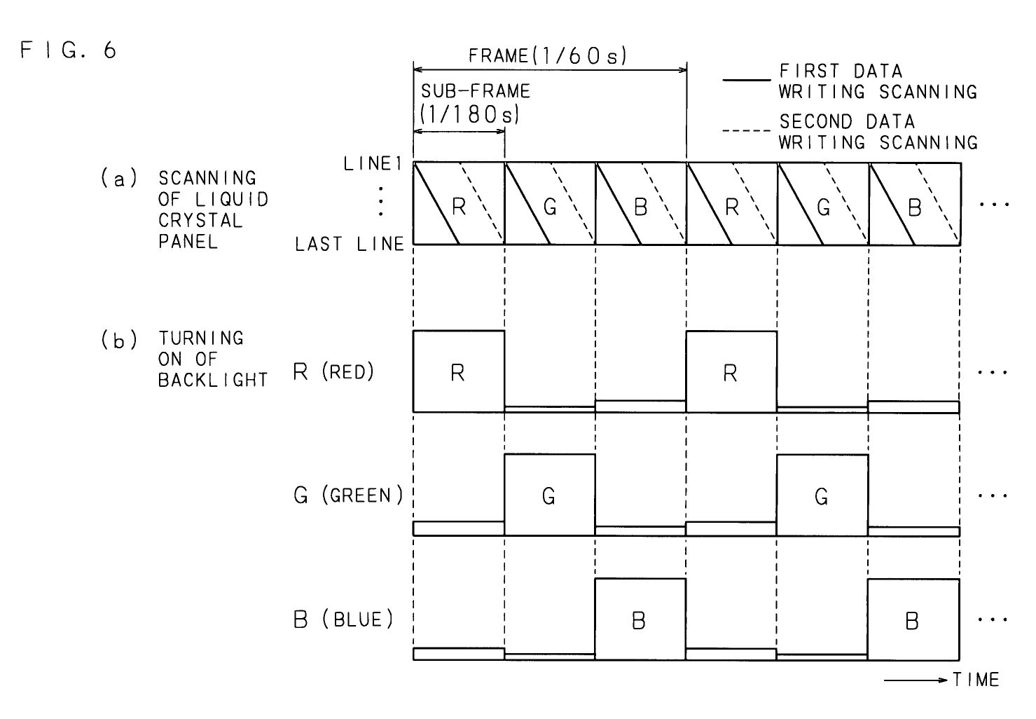

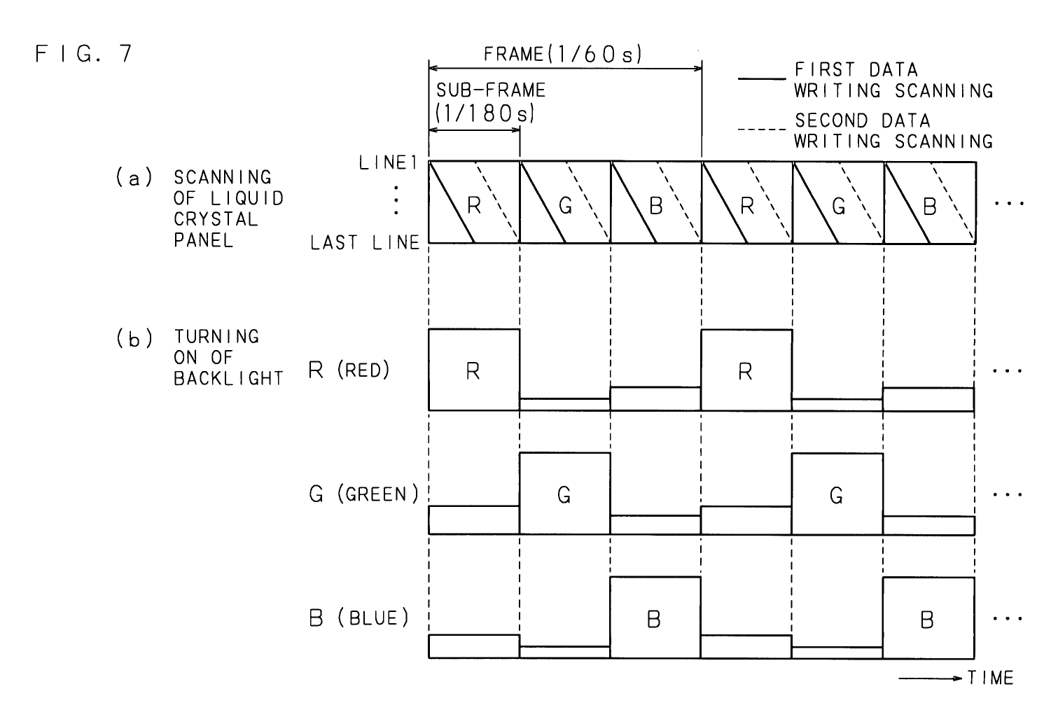

FIGS. 6 and 7 show driving sequences in a first and second example of the second control method. (a) of FIG. 6 and (a) of FIG. 7 show the scanning timing of each line of the liquid crystal panel 21. (b) of FIG. 6 and (b) of FIG. 7 show the turning-on timings and light emission intensities of red, green and blue of the backlight 22.

The description of the scanning timing (two writing scannings) of each line of the liquid crystal panel 21 shown in (a) of FIG. 6 and (a) of FIG. 7 is omitted because it is the same as the above-described one shown in (a) of FIG. 5.

On the other hand, in the control of turning on of red, green and blue of the backlight 22, as shown in (b) of FIG. 6 and (b) of FIG. 7, in the first subframe in which writing scanning of the pixel data of red is performed, not only the red light but also the lights of the other colors (green and blue) are emitted (the emission intensity of the red light >the emission intensities of the green and blue lights). In the second subframe in which writing scanning of the pixel data of green is performed, not only the green light but also the lights of the other colors (red and blue) are emitted (the emission intensity of the green light>the emission intensities of the red and blue lights). In the third subframe in which writing scanning of the pixel data of blue is performed, not only the blue light but also the lights of the other colors (red and green) are emitted (the emission intensity of the blue light>the emission intensities of the red and green lights).

Compared with the first control method, the second control method is suitable for coarse image display such as enlarged display in which the color reproduction region in the chromaticity diagram is small and the color purity is low. In the second example ((b) of FIG. 7), the light emission intensities of the other colors in each subframe are higher, the color reproduction region is smaller, and the color purity is lower than those in the first example ((b) of FIG. 6).

The control method determining circuit 36 determines the control method to be used from among the first control method and the first and second examples of the second control method according to the resolution of the image display based on the inputted pixel data PD. Specifically, in the case of high-resolution image display (fine image display), the first control method offering high color purity is selected, and in the case of comparatively low-resolution image display (coarse image display), the second control method offering slightly lower color purity (the first or second example) is selected. When the second control method is selected, selection between the first and second examples can be further made according to the resolution of the image display.

### <EXAMPLE>

The glass substrate 4 having the TFTs 41, the signal lines 42, the scanning lines 43 and the pixel electrodes 40 (640×480 pixels, 3.2 inches diagonally) and the glass substrate 2 having the common electrode 3 were washed, and then, polyimide was applied thereto and baked at 200 Å for one hour to thereby form polyimide films of approximately 200 Å as the alignment films 11 and 12. Further, the alignment films 11 and 12 were rubbed with a rayon cloth, and the two substrates were placed one on another so that the rubbing directions were parallel to each other, whereby an empty panel was formed in which a gap was held between the substrates by spacers 14 made of silica and with an average grain diameter of 1.6 μm.

A bistable ferroelectric liquid crystal material (for example, a material disclosed in A. Mochizuki et al., Ferroelectrics, 133,353 [1991]) the main component of which was a naphthalene-based liquid crystal was sealed in the empty panel, thereby forming the liquid crystal layer 13. The magnitude of the spontaneous polarization of the ferroelectric liquid crystal material being sealed in was 6 nC/cm2. The formed panel was sandwiched between the two polarizers 1 and 5 in the crossed nicols state to form the liquid crystal panel 21, and setting was made so that the dark state was when the major axis direction of the ferroelectric liquid crystal molecules tilted in one way.

The liquid crystal panel 21 formed in this way and the backlight 22 having as the light source the LED array 7 including twelve LEDs in which one chip is constituted by LED elements emitting lights of red (R), green (G) and blue (B) were placed one on another, and color display of an enlarged image was performed in accordance with the driving sequence of the first example of the second control method as shown in FIG. 6. Consequently, the areas of the colors could sufficiently be recognized, and no color intenseness (visual irritation) was perceived. In addition, color breakup could be suppressed.

Moreover, color display of an image in which single-color areas of red, green and blue occupy a large area was performed in accordance with the driving sequence of the second example of the second control method as shown in FIG. 7. Consequently, the single-color areas could sufficiently be recognized, and no color intenseness (visual irritation) was perceived. In addition, color breakup could be suppressed.

Moreover, color display of an image in which the color areas are fine was performed in accordance with the driving sequence of the first control method as shown in FIG. 5. Consequently, high-resolution and high-color-purity display could be realized. Color breakup was slightly perceived.

### <Comparative Example>

A liquid crystal panel and a backlight similar to those of the above-described example were placed one on another, and color display of an enlarged image and an image in which single-color areas of red, green and blue occupy a large area was performed in accordance with the driving sequence of the first control method as shown in FIG. 5. Consequently, in the display of both of the images, although the areas of the colors could sufficiently be recognized, color intenseness (visual irritation) was perceived. Color breakup was also perceived.

While in the above-described embodiment, the light emission intensities of the other colors are varied to set two examples (the first example and the second example) in the second control method, in this case, the number of settings is not limited to two but may be one or not less than three.

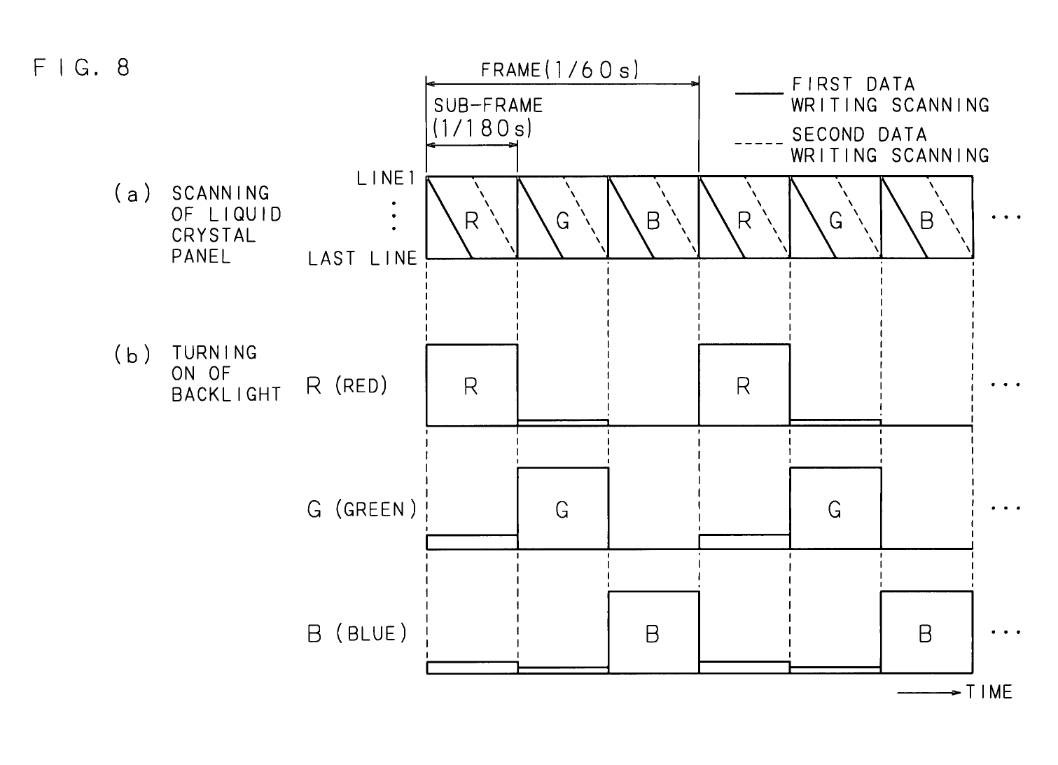

FIG. 8 shows a driving sequence in another example of the second control method. (a) of FIG. 8 shows the scanning timing of each line of the liquid crystal panel 21. (b) of FIG. 8 shows the turning-on timings and light emission intensities of red, green and blue of the backlight 22. The description of the scanning timing (two writing scannings) of each line of the liquid crystal panel 21 shown in (a) of FIG. 8 is omitted because it is the same as the above-described one shown in (a) of FIG. 5.

In the control of turning on of red, green and blue of the backlight 22, as shown in (b) of FIG. 8, as in the first and second examples, in the first subframe in which writing scanning of the pixel data of red is performed, not only the red light but also the lights of the other colors (green and blue) are emitted (the emission intensity of the red light>the emission intensities of the green and blue lights), in the second subframe in which writing scanning of the pixel data of green is performed, not only the green light but also the lights of the other colors (red and blue) are emitted (the emission intensity of the green light>the emission intensities of the red and blue lights), and in the third subframe in which writing scanning of the pixel data of blue is performed, unlike the first and second examples, only the blue light is emitted.

Which example of the method (for example, any one of FIGS. 6 to 8) to select in the second control method is determined according to in which direction the chromaticity diagram is shortened. In other words, the driving sequence (the light emission timings and is light emission intensities of the colors) in the second control method can be set so that the chromaticity diagram desired by the user is obtained.

While selection between the first control method and the second control method is made according to the inputted pixel data in the above-described embodiment, unlike this, the selection may be made according to the user's selection input.

While a ferroelectric liquid crystal material having spontaneous polarization is used in the above-described embodiment, similar effects are obtained when a different liquid crystal material having spontaneous polarization such as an anti-ferroelectric liquid crystal material is used and when a nematic liquid crystal material having no spontaneous polarization is used. The present invention is not limited to transmissive type liquid crystal display devices but is applicable to reflective type liquid crystal display devices and front/rear projectors.

While a field sequential liquid crystal display device using a transmissive type liquid crystal display element as a display element is described as an example, the present invention is similarly applicable to different kinds of field sequential display lo devices using a different display element such as a digital micromirror device (DMD).

In the display method or the display device according to an embodiment, the following are used: the first control method in which in synchronism with the input of the pixel data of one specific luminous color, the light of the one specific luminous color is emitted and the lights of the other luminous colors are not emitted; and the second control method in which in synchronism with the input of the pixel data of one specific luminous color, the light of the one specific luminous color and the lights of the other luminous colors are emitted. When high-resolution image display is provided, light emission control is performed according to the first control method to increase the color purity. When coarse display such as enlarged display is provided, light emission control is performed according to the second control method to decrease the color purity. Moreover, according to the second control method, since the color is closer to white, color breakup can be suppressed.

In the display method or the display device according to an embodiment, in the second control method, the light emission intensities of the other luminous colors are varied to realize a plurality of kinds of color reproduction regions (color purities) having different patterns. By reducing the light emission intensities of the other luminous colors in the second control method, the color reproduction region is widened and the color purity is increased. On the contrary, by increasing the light emission intensities of the other luminous colors in the second control method, the color reproduction region is narrowed and the color purity is decreased.

In the display method or the display device according to an embodiment, the plurality of colors of lights incident on the display element are red light, green light and blue light. Therefore, full-color display can be performed.

In the display device according to an embodiment, the display element is a liquid crystal display element. Since a liquid crystal display element is used as the display element, a small and thin direct-view type display device and a projector type display device that can be provided with a large screen can be realized.

In the display device according to an embodiment, the liquid crystal material used for the liquid crystal display element has spontaneous polarization. Since a liquid crystal material having spontaneous polarization such as a ferroelectric liquid crystal material or an anti-ferroelectric liquid crystal material is used as the liquid crystal material, a fast responsivity of not more than 2 ms necessary for field sequential liquid crystal display devices is easily realized, so that stable display can be provided.

What is claimed is:

1. A display method in a field sequential manner, comprising:
switching a plurality of color lights sequentially with time;
synchronizing an emission timing of each color light with an input of pixel data of the color light concerning an image to be displayed in multicolor; and
controlling intensities of the respective color lights so as to obtain a plurality of color reproduction regions each of which has different area from the other regions.

2. The method according to claim 1, further comprising:
emitting one color light with the usage synchronized with the input of the pixel data of the one color light and not emitting other color lights; and
emitting the one color light and the other color lights with the usage synchronized with the input of the pixel data of the one color light, so as to obtain the plurality of color reproduction regions each of which has the different area from the other regions.

3. The method according to claim 2, wherein the emitting includes the other lights different from one another, when emitting the one color light and the other color lights with the usage synchronized with the input of the pixel data of the one color light, so as to obtain the plurality of color reproduction regions each of which has the different area from the other regions.

4. The method according to claim 1, wherein the plurality of color lights are red, green and blue.

5. A display device in a field sequential manner, the manner including:
switching the plurality of color lights sequentially with time; and
synchronizing an emission timing of each color light with an input, to a display element, of pixel data of the color light concerning an image to be displayed in multicolour, the device comprising
a controller capable of performing the operation of controlling intensities of the respective lights so as to obtain a plurality of color reproduction regions each of which has different area from the other regions.

6. The device according to claim 5, wherein the controller switches the operation between:
a first manner of using one color light with the usage synchronized with the input of the pixel data of the one color light and not using other color lights; and
a second manner of using the one color light and the other color lights with the usage synchronized with the input of the pixel data of the one color light,
so as to obtain the plurality of color reproduction regions each of which has the different area from the other regions.

7. The device according to claim 6, wherein in the second manner the controller is configured to use the other lights different from one another in intensity,
so as to obtain the plurality of color reproduction regions each of which has the different area from the other regions.

8. The device according to claim 5, wherein the plurality of color lights are red, green and blue.

9. The device according to claim 5, wherein the display element is a liquid crystal display element.

10. The device according to claim 9, wherein a liquid crystal material included in the liquid crystal display element has spontaneous polarization.
